(19) United States
(12) Patent Application Publication
(10) Pub. No.: US 2006/0059618 A1
(43) Pub. Date: Mar. 23, 2006

(54) Bath apparatus

(75) Inventors: Stephen Chung, Taipei (TW); Roman S. Ferber, West Bloomfield, MI (US)

Correspondence Address: BROOKS KUSHMAN P.C., 1000 TOWN CENTER, TWENTY-SECOND FLOOR, SOUTHFIELD, MI, 48075, US

(73) Assignee: HoMedics, Inc., Commerce Township, MI (US)

(21) Appl. No.: 10/947,826

(22) Filed: Sep. 23, 2004

(51) Int. Cl. E03C 1/00; A47K 3/022; A61H 35/00

(52) U.S. Cl. 4/622

(57) ABSTRACT

An apparatus for bathing a body part, such as the feet, includes a bath chamber for containing a fluid and receiving the body part therein. The bath chamber includes a bottom surface and a wall structure extending upwardly therefrom, where the bottom surface includes a plurality of raised projections having a stone-like appearance.

### BACKGROUND OF THE INVENTION

1. Field of the Invention

This invention relates to an apparatus for bathing body parts, such as the feet or hands.

2. Background Art

Most people experience foot problems at some time in their lives. This is not surprising, considering that many people are employed in jobs that require them to be on their feet all day. In fact, even an average day of walking can exert force equal to several hundred tons of pressure on the feet.

In an attempt to alleviate a variety of podiatric problems, bathing of the feet has become a recognized therapeutic method. For example, soaking soothes the feet and aids in recovery from fatigue. Bathing of the feet also stimulates the circulation of blood therethrough, which results in increased metabolism and excretion. In addition, foot bathing facilitates the removal of painful growths such as calluses, bunions, and corns.

Many types of foot baths have been utilized as therapeutic devices for the feet. Typically, foot baths provide heated water for which the temperature is maintained via electrical means. In addition, current foot baths often provide massage to the feet through vibration of the foot bath. Vibratory massage enhances the therapeutic results achieved with soaking alone by further increasing circulation, as well as relaxing and massaging the muscles.

Massage of the soles of the feet is often accomplished with movable rollers attached to the bottom of the bath chamber. While rollers provide one means of massaging the feet, it would be desirable to provide a massage medium that not only massages the feet, but also facilitates a more multi-sensory relaxation experience for the user.

### SUMMARY OF THE INVENTION

Accordingly, an apparatus for bathing a body part, such as the feet, is provided which includes a bath chamber arranged to contain a fluid and receive the body part therein. The bath chamber includes a bottom surface and a wall structure extending upwardly therefrom, where the bottom surface includes a plurality of raised projections having a stone-like appearance.

In accordance with the present invention, the apparatus can include a heater, such as a resistive heating element, in communication with the bath chamber for maintaining the heat of the fluid contained therein. The wall structure can include one or more vents through which fluid can flow into contact with the heater. The apparatus can further include a vibration assembly in communication with the bath chamber for imparting vibration to the bath chamber. According to one aspect of the present invention, the vibration assembly can include a motor affixed to an underside of the bath chamber, an output shaft rotatably driven by the motor, and a counterweight affixed to the output shaft.

In addition, the apparatus can include an air pump in communication with the bath chamber bottom surface, where the bath chamber bottom surface includes a plurality of egress holes formed therein through which air from the pump is directed into the bath chamber in order to generate air bubbles in the fluid contained therein. More particularly, a base wall is connected to the wall structure, at least one tube is connected between the pump and the base wall, and an air plate is disposed between the base wall and the bath chamber bottom surface. The air plate includes a plurality of holes formed therein, where air is directed from the pump through the air plate holes and out the egress holes of the bath chamber bottom surface to generate air bubbles in the fluid contained within the bath chamber.

A lid can be attached to the wall structure and arranged to at least partially cover the bath chamber, and a selector is provided for determining a mode of activation of the apparatus. According to one aspect of the present invention, the selector is a push-activated, multifunction switch which allows for multiple modes of activation of the apparatus. The projections can have varying sizes and colors, and can be affixed within the bottom surface or movable within the bottom surface.

Still further, the apparatus according to the present invention can include a contact area on the wall structure having a heating member provided thereon for providing heat to a body part when the body part is placed on the contact area. According to one aspect of the present invention, the heating member uses infrared rays. The contact area can also include a massage center having at least one massage attachment for massaging a body part when the body part engages the massage attachment. Rotation of the massage attachment can be motorized, and can be activated by pressure of the body part on the massage attachment.

According to another aspect of the present invention, a foot bath is provided having a housing including a base wall and a side wall structure extending upwardly therefrom. A floor member is disposed on the base wall, where the side wall structure and the floor member together define a bath chamber for containing a fluid and receiving a user's feet therein. The floor member includes a plurality of raised projections having an appearance which gives the visual impression of a stone floor.

In further accordance with the present invention, an apparatus for bathing a body part is provided which includes a bath chamber for containing a fluid and receiving the body part therein. The bath chamber includes a bottom surface and a wall structure extending upwardly therefrom, where the bottom surface includes a plurality of raised projections varying in at least one of size and color and having a stone-like appearance. A heater is provided in communication with the bath chamber for maintaining the heat of the fluid contained therein. The apparatus also includes an air pump in communication with the bath chamber bottom surface, the bath chamber bottom surface including a plurality of egress holes formed therein through which air from the pump is directed into the bath chamber in order to generate air bubbles in the fluid contained therein. The apparatus further includes a vibration assembly in communication with the bath chamber for imparting vibration to the bath chamber.

The above features and advantages along with other features and advantages of the present invention are readily apparent from the following detailed description of the invention when taken in connection with the accompanying drawings.

### BRIEF DESCRIPTION OF THE DRAWINGS

FIG. 1 is a perspective view of a bath apparatus constructed in accordance with the present invention;

FIG. 2 is a top plan view of the bath apparatus of FIG. 1;

FIG. 3 is a fragmentary, cross-sectional view of the bath apparatus according to the present invention taken along line 3-3 of FIG. 2;

FIG. 4 is a bottom plan view of the pump, heating, and vibration assemblies located on the underside of the bath chamber;

FIG. 5 is an exploded view of the bath apparatus of FIG. 1;

FIG. 6 is a cross-sectional view of the bath apparatus according to the present invention taken along line 6-6 of FIG. 2; and

FIG. 7 is a top plan view of a bath apparatus according to another aspect of the present invention.

### DETAILED DESCRIPTION OF EMBODIMENTS OF THE PRESENT INVENTION

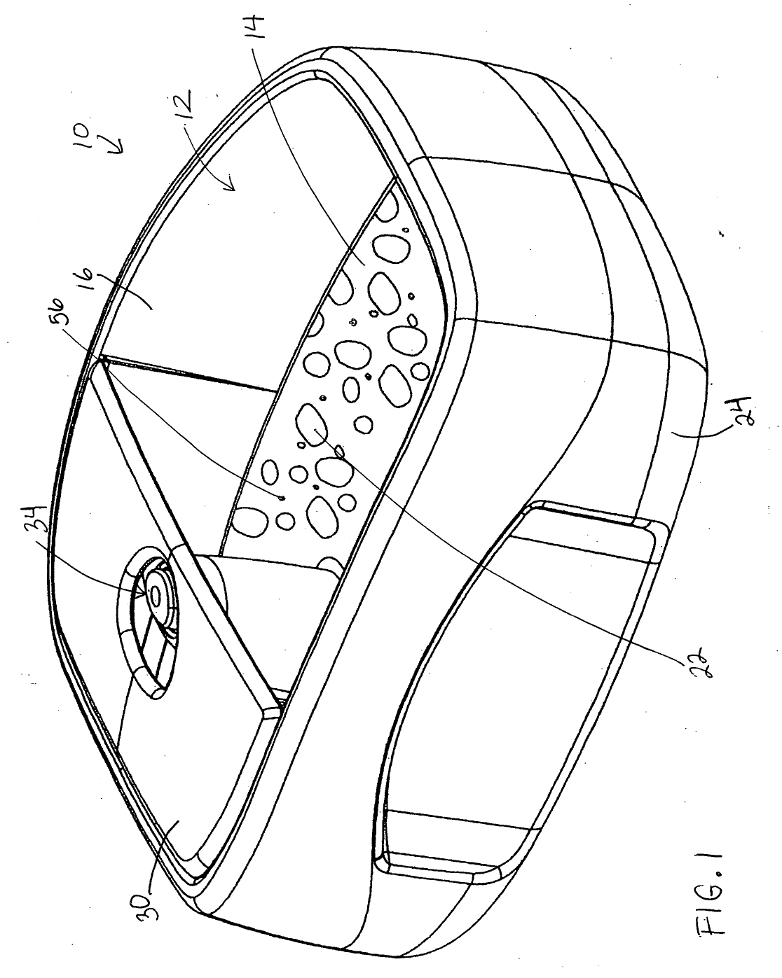

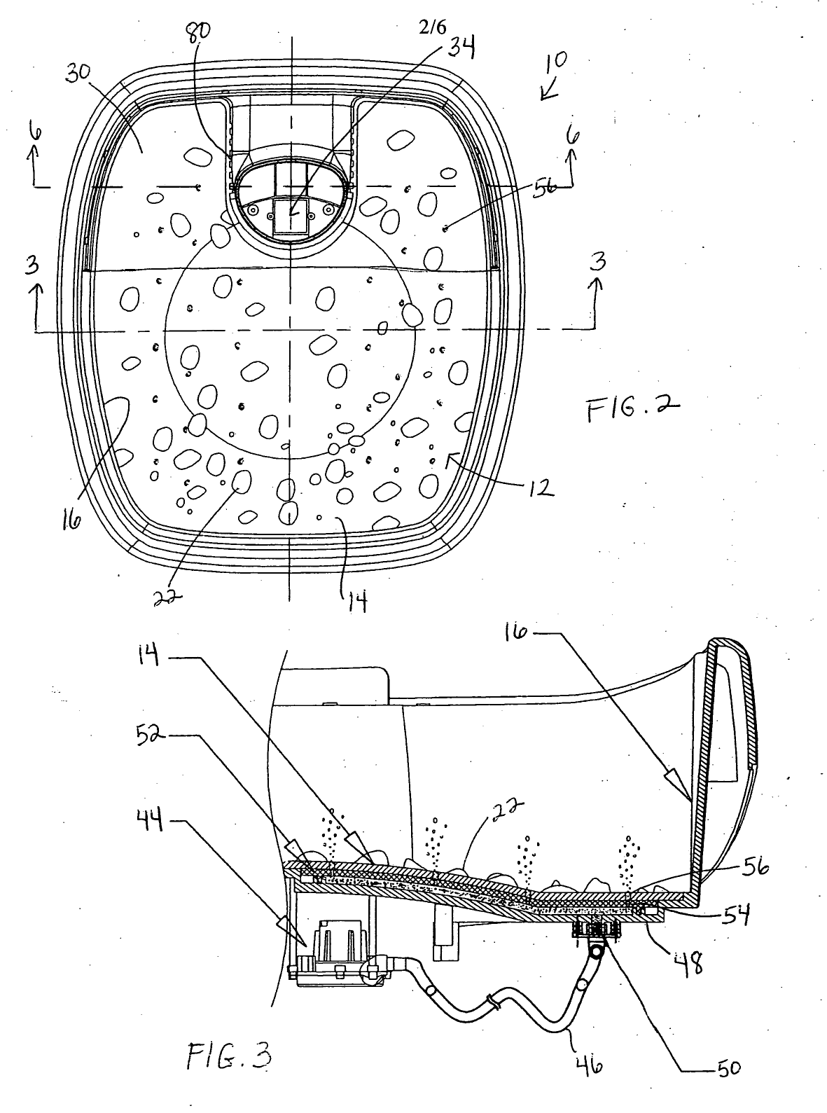

Referring to FIGS. 1 and 2, a bath apparatus constructed according to the present invention is depicted and designated generally by reference numeral 10. Bath apparatus 10 can be used to provide heat, bubbles, and massage therapy to body parts, such as the feet. Bath apparatus 10 is preferably constructed from a plastic material so as to be lightweight and portable, as well as durable, leakproof, and corrosion resistant. Although bath apparatus 10 is illustrated and described herein as being particularly adaptable for use as a foot bath, it is understood that bath apparatus 10 of the present invention may be used for bathing other body parts, such as the hands.

Bath apparatus 10 includes an upper housing or bath chamber 12 for containing fluid, such as water, and receiving a body part, such as the foot, therein. Bath chamber 12 includes a floor member or bottom surface 14 and a wall structure 16 extending upwardly therefrom. Bottom surface 14 can be rigid or alternatively can be constructed from a flexible material, and can either be arranged to be affixed within bath apparatus 10 or to be removable. Bottom surface 14 can be generally parallel to a supporting surface on which bath apparatus 10 is placed or can be sloped to be higher in the middle as compared with the sides thereof. Alternatively, bottom surface 14 could be slanted downwardly toward the user. Bath chamber 12 is of a length and width to accommodate the feet of an adult user, wherein sufficient space is provided to permit the user to readily insert and remove his/her feet and to allow each foot to be moved about within bath chamber 12. For use, bath chamber 12 is filled with fluid such that a user, preferably seated, submerses his/her feet up to approximately the height of the ankles.

Referring again to FIGS. 1 and 2, bottom surface 14 of bath chamber 12 includes a plurality of raised projections 22 which can be of varying shapes and sizes, and can also have varying colors such as grays, browns, blacks, greens, and others. Projections 22 have a stone-like appearance, so as to give the visual impression and feel of a stone floor, such as in a river rock bed. In addition, bottom surface 14 can have a grayish or brownish coloration as would be found in a river bottom. Projections 22 function to provide pressure points to the feet and to massage the feet upon contact, and also allow water and heat to flow under the feet to improve blood circulation. A user can glide his/her foot back and forth across projections 22 to help relieve tightness and tiredness along soles of feet, as well as for reflexology purposes. Projections 22 can be affixed in bottom surface 14 so as to be stationary, or alternatively could be movable within bottom surface 14, such as having constrained translational or rotational movement.

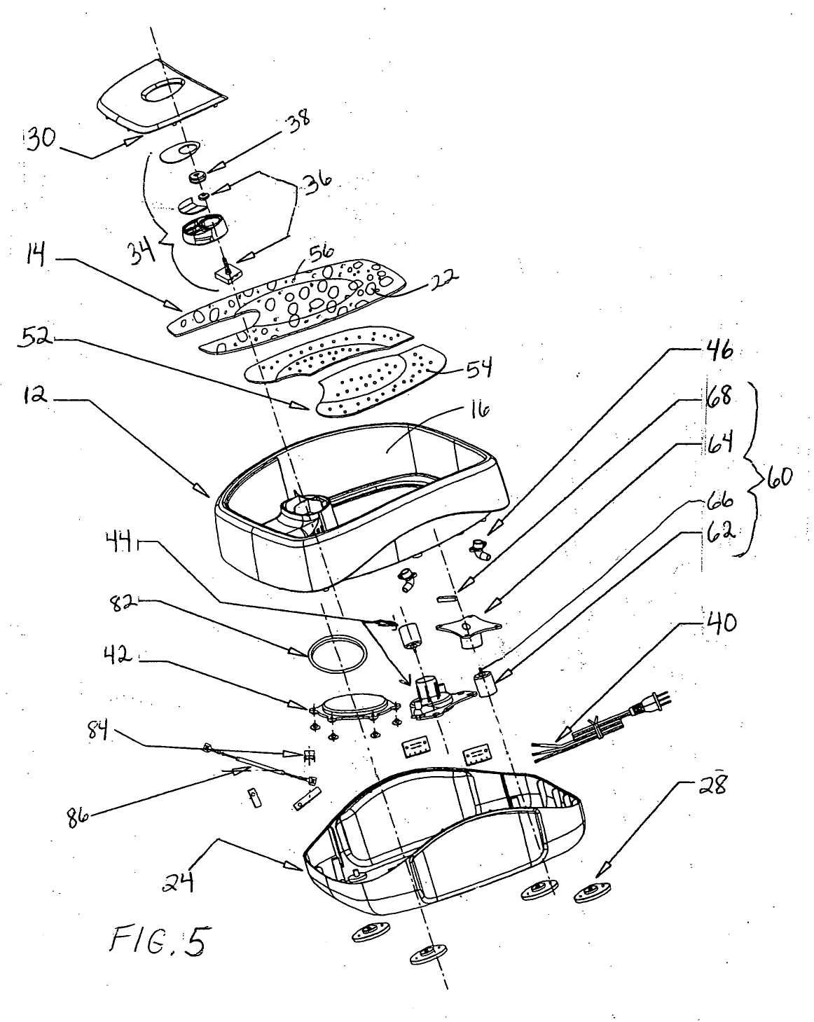

With reference to FIG. 1 and the exploded view of FIG. 5, bath chamber 12 is received in a lower housing 24 which provides a location for the various mechanical/electrical assemblies of bath apparatus 10 described below with reference to FIGS. 4-6. Lower housing 24 is preferably provided with feet 28 constructed from a material such as rubber to prevent movement of bath apparatus 10 along a supporting surface.

As shown in FIGS. 1 and 2, bath apparatus 10 further includes a lid 30 arranged to be removably attached to wall structure 16 to at least partially cover bath chamber 12, such as for preventing any accidental splashing of water. Lid 30 is preferably constructed from a plastic material, and is sufficiently rigid so that it can be utilized to support one or both of a user's feet resting thereon.

Bath apparatus 10 further includes a function selector 34 accessible to the user, such as adjacent lid 30. Selector 34 preferably comprises a multifunction, push button switch 36 and can be depressed by a user, such as via a user's toes, to selectively provide various combinations of heat, vibratory massage, bubbles, or other functions to the feet. Selector 34 includes a flexible, preferably rubber, cover 38 which provides a waterproof design yet is flexible enough to allow for depression using a user's foot or toe. Wiring interconnects selector 34 with each of the mechanical/electrical assemblies described below with reference to FIGS. 4-6 which are powered via connection of a standard power cord 40 to any 110 V AC outlet. According to one aspect of the present invention, selector 34 can be set to provide three different combinations of bath functions: 1) vibratory massage and chamber heat; 2) vibratory massage, bubbles, and chamber heat; and 3) bubbles and chamber heat. However, it is understood that other combinations of bath functions are fully contemplated in accordance with the present invention. Additionally, it is contemplated that selector 34 could be replaced by multiple switches or a rotatable knob.

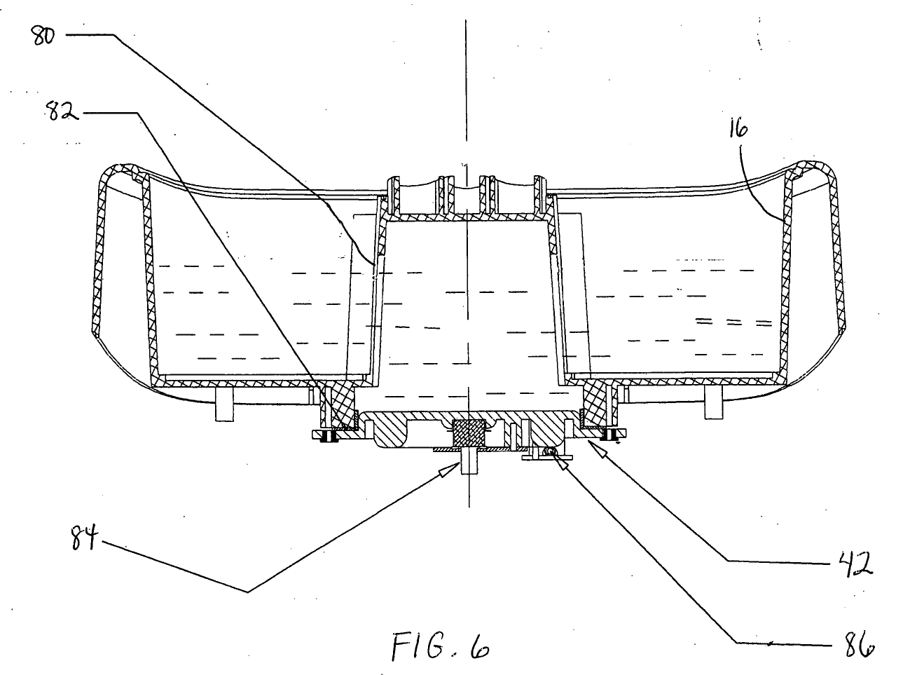

As best shown in FIGS. 4 and 6, a heater 42 is secured underneath bottom surface 14 in communication with fluid provided in bath chamber 12. Upon receiving electrical power, as determined by selector 34, heater 42 is operable to conduct heat to the fluid contained within bath chamber 12. More specifically, wall structure 16 includes one or more vents 80 adjacent selector 34 through which fluid can flow into contact with heater 42 and be heated. A seal, such as a silicon ring 82, surrounds heater 42 and prevents fluid from escaping from bath chamber 12 into lower housing 24. According to one aspect of the present invention, heater 42 comprises a resistive heating element constructed of aluminum, although the use of other types of heaters is fully contemplated. A thermostat 84 and fuse 86 are provided in communication with heater 42 to provide temperature regulation and shut-off functionality. The heated fluid maintained by heater 42 relieves tired muscles and promotes circulation of the blood for the user.

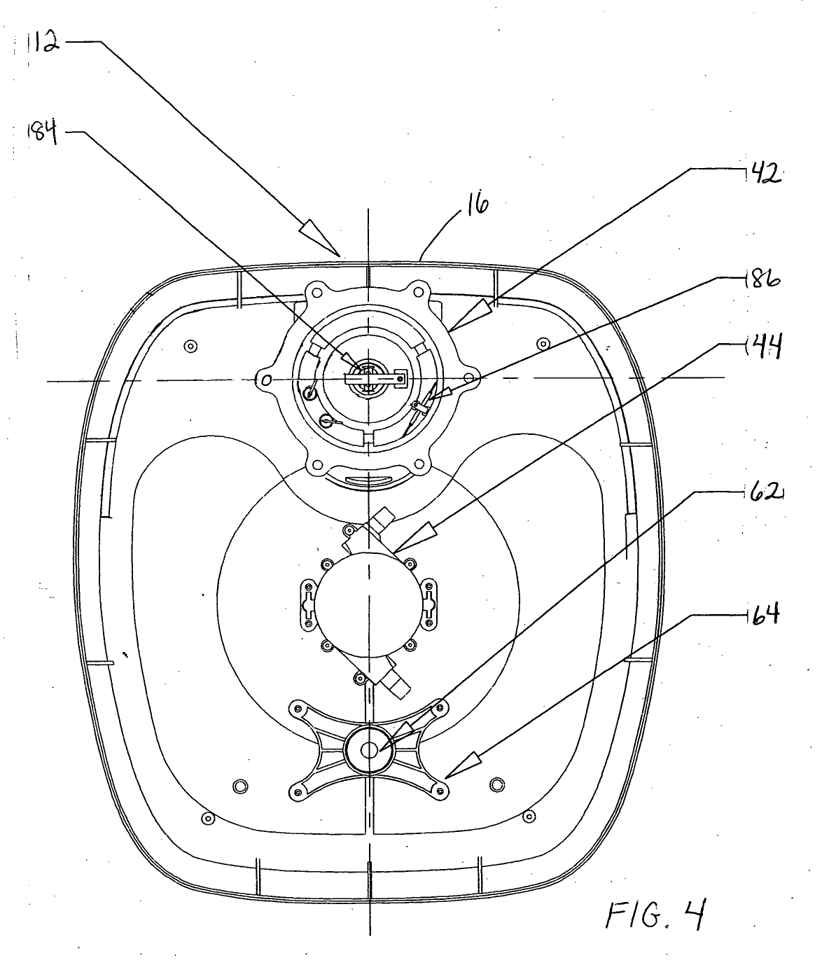

Bath apparatus 10 further includes a pump 44 for directing air into bath chamber 12 to generate air bubbles in the water contained therein. As shown in the fragmentary cross-sectional view of FIG. 3, pump 44 forces air through one or more tubes 46 which are connected to a base wall 48 attached to wall structure 16. According to one aspect of the present invention, a valve 50 is provided at the junction where each tube 46 meets base wall 48 such that fluid from bath chamber 12 is prevented from flowing backwards toward pump 44. An air plate 52 overlies base wall 48 and includes a plurality of holes 54 provided therein. As shown in FIG. 5, two separate air plates 52 can be provided for each side of bath chamber 12. Bottom surface 14, in turn, overlies air plate 52 and includes a plurality of egress holes 56 positioned to at least partially vertically align with holes 54 of air plate 52. Air is pumped through tube 46, through holes 54 of air plate 52, and out egress holes 56 of bottom surface 14 to form air bubbles in the fluid contained in bath chamber 12. It is understood that other hole 54 and egress hole 56 configurations in addition to the example illustrated herein are fully contemplated in accordance with the present invention. Furthermore, it is understood that air plate 52 could be eliminated, and that bottom surface 14 could directly overlie base wall 48.

With reference to FIGS. 4 and 5, bath apparatus 10 according to the present invention further includes a vibration assembly 60 in communication with bath chamber 12 for imparting vibration to bath chamber 12 to provide a massaging effect to a user's feet as the feet are resting on projections 22. Vibration assembly 60 includes a motor 62 affixed to an underside of bath chamber 12 by a motor support bracket 64, an output shaft 66 rotatably driven by motor 62, and a counterweight 68 affixed to output shaft 66. When motor 62 is electrically powered, as determined by selector 34, rotation of output shaft 66 and attached counterweight 68 imparts vibrations to motor support bracket 64, and these vibrations are then transferred to bath chamber 12 and the fluid contained therein in order to massage the feet. It is fully contemplated that variable vibration intensities could be provided in accordance with the present invention.

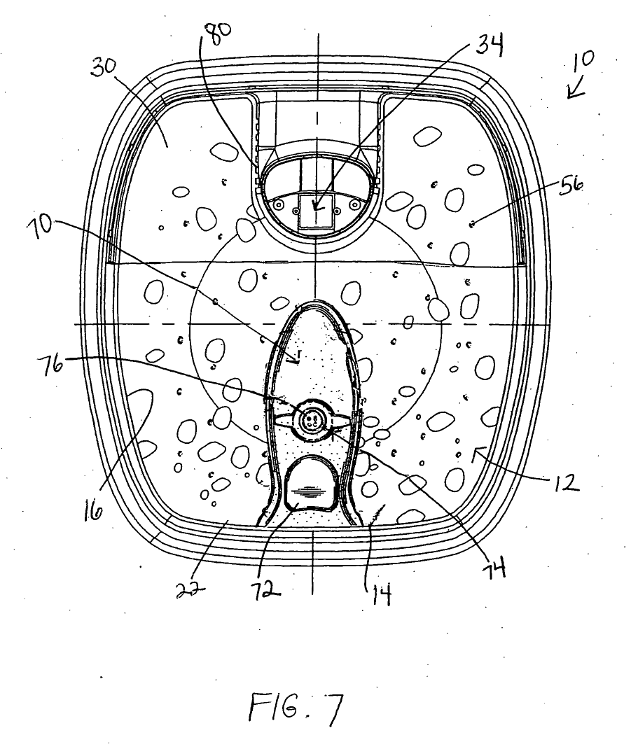

Turning to FIG. 7, bath apparatus 10 according to another aspect of the present invention includes a contact area 70 which has a heating member 72 and a massage center 74 for providing additional targeted therapy to the feet. It is understood that contact area 70 can have any location on bath apparatus 10 that is accessible to the user, typically a location that remains uncovered by fluid. Heating member 72 provides heat to the foot surface when a user's foot is placed on contact area 70, and advantageously provides the capability of focusing heat on the specific region of the foot desired by the user. According to one aspect of the present invention, heating member 72 uses infrared rays, as infrared rays allow heat to penetrate deep underneath the surface of the skin, causing the pores of the skin to be opened and promoting metabolism and excretion within the body through increased blood circulation. The applied pressure of the foot on heating member 72 can be adjusted by the user for optimum comfort. Although the surface of heating member 72 is shown herein to be generally flat, heating member 72 could have any contour suitable for contact with a user's foot.

With further reference to FIG. 7, contact area 70 of bath apparatus 10 can also include a massage center 74 having one or more interchangeable massage attachments 76 for massaging the user's foot upon engagement. As with heating member 72, massage center 74 advantageously allows for massage to be targeted to specific locations of the foot such as the ball, heel, or arch. Massage attachments 76 can be stationary within contact area 70, or alternatively rotation of massage attachments 76 can be motorized. In this latter alternative, the motorized rotation of massage attachments 76 can optionally be activated by pressure of the user's foot applied thereon. Different massage attachments 76 for use with bath apparatus 10 include, but are not limited to, raised nodes (shown), a pumice stone, and a brush. Further details regarding heating member 72 and massage center 74 are described in U.S. Pat. Nos. 6,385,795 and 6,393,633, both of which are incorporated by reference herein.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An apparatus for bathing a body part, the apparatus comprising:
a bath chamber arranged to contain a fluid and receive the body part therein, the bath chamber including a bottom surface and a wall structure extending upwardly therefrom, the bottom surface including a plurality of raised projections having a stone-like appearance.

2. The apparatus according to claim 1, wherein the projections have varying sizes.

3. The apparatus according to claim 1, wherein the projections have varying colors.

4. The apparatus according to claim 1, wherein the projections are affixed within the bottom surface.

5. The apparatus according to claim 1, wherein the projections are movable within the bottom surface.

6. The apparatus according to claim 1, further including a heater in communication with the bath chamber for maintaining the heat of the fluid contained therein.

7. The apparatus according to claim 6, wherein the heater includes a resistive heating element.

8. The apparatus according to claim 6, wherein the wall structure includes at least one vent through which fluid can flow into contact with the heater.

9. The apparatus according to claim 1, further including an air pump in communication with the bath chamber bottom surface, the bath chamber bottom surface including a plurality of egress holes formed therein through which air from the pump is directed into the bath chamber in order to generate air bubbles in the fluid contained therein.

10. The apparatus according to claim 9, further comprising a base wall connected to the wall structure, at least one tube connected between the pump and the base wall, and an air plate disposed between the base wall and the bath chamber bottom surface, the air plate having a plurality of holes formed therein, wherein air is directed from the pump through the air plate holes and out the egress holes of the bath chamber bottom surface to generate air bubbles in the fluid contained within the bath chamber.

11. The apparatus according to claim 1, further including a vibration assembly in communication with the bath chamber for imparting vibration to the bath chamber.

12. The apparatus according to claim 11, wherein the vibration assembly includes a motor affixed to an underside of the bath chamber, an output shaft rotatably driven by the motor, and a counterweight affixed to the output shaft.

13. The apparatus according to claim 1, further comprising a lid attached to the wall structure and arranged to at least partially cover the bath chamber.

14. The apparatus according to claim 1, further comprising a selector for determining a mode of activation of the apparatus.

15. The apparatus according to claim 14, wherein the selector is a push-activated, multifunction switch which allows for multiple modes of activation of the apparatus.

16. The apparatus according to claim 1, wherein the wall structure includes a contact area having at least one of a heating member for providing heat to a body part, and a massage center including at least one massage attachment for massaging a body part.

17. The apparatus according to claim 16, wherein the heating member uses infrared rays.

18. The apparatus according to claim 16, wherein rotation of the at least one massage attachment is motorized.

19. The apparatus according to claim 18, wherein motorized rotation of the at least one massage attachment is activated by pressure of the body part on the massage attachment.

20. A foot bath comprising:
a housing including a base wall and a side wall structure extending upwardly therefrom;
a floor member disposed on the base wall, wherein the side wall structure and the floor member together define a bath chamber for containing a fluid and receiving a user's feet therein, the floor member including a plurality of raised projections having an appearance which gives the visual impression of a stone floor.

21. The foot bath according to claim 20, wherein the projections vary in at least one of size and color.

22. The foot bath according to claim 20, further including a heater in communication with the bath chamber for maintaining the heat of the fluid contained therein.

23. The foot bath according to claim 20, further including an air pump in communication with the bath chamber bottom surface, the bath chamber bottom surface including a plurality of egress holes formed therein through which air from the pump is directed into the bath chamber in order to generate air bubbles in the fluid contained therein.

24. The foot bath according to claim 20, further including a vibration assembly in communication with the bath chamber for imparting vibration to the bath chamber.

25. The foot bath according to claim 20, further comprising a lid attached to the wall structure and arranged to at least partially cover the bath chamber.

26. The foot bath according to claim 20, further comprising a selector for determining a mode of activation of the apparatus.

27. The foot bath according to claim 20, wherein the wall structure includes a contact area adapted to be uncovered by fluid contained in the bath chamber, the contact area including at least one of a heating member and a massage center.

28. An apparatus for bathing a body part, the apparatus comprising:
a bath chamber for containing a fluid and receiving the body part therein, the bath chamber including a bottom surface and a wall structure extending upwardly therefrom, the bottom surface including a plurality of raised projections varying in at least one of size and color and having a stone-like appearance;
a heater in communication with the bath chamber for maintaining the heat of the fluid contained therein;
an air pump in communication with the bath chamber bottom surface, the bath chamber bottom surface including a plurality of egress holes formed therein through which air from the pump is directed into the bath chamber in order to generate air bubbles in the fluid contained therein; and
a vibration assembly in communication with the bath chamber for imparting vibration to the bath chamber.
